(19) United States
(12) Patent Application Publication
(10) Pub. No.: US 2003/0191685 A1
(43) Pub. Date: Oct. 9, 2003

(54) Method and system for event-centric user profiling and targeting

(76) Inventor: Jeffrey M. Reese, Atlanta, GA (US)

Correspondence Address: NEEDLE & ROSENBERG, P.C., SUITE 1000, 999 PEACHTREE STREET, ATLANTA, GA, 30309-3915, US

(21) Appl. No.: 09/772,562

(22) Filed: Jan. 30, 2001

Related U.S. Application Data
(60) Provisional application No. 60/179,258, filed on Jan. 31, 2000.

(51) Int. Cl. G06F 17/60

(52) U.S. Cl. 705/14

(57) ABSTRACT

A method and system provide event-centric personalized messages. Information regarding a user is received, including event-related information describing a desire by the user to receive information associated with an event at one or more specific time(s) or range(s) of time(s) and/or at one or more specific destination(s). Messages are then sent to the user at the specific time and/or at the specific destination corresponding to that contained in the received information. The messages are selected based on the received information regarding the user. The received information may include information regarding the user's behavior with regard to messages previously received, demographic/psychographic information regarding the user, and information provided by a third party regarding the user. The messages may also be selected based on information deduced from the received information regarding the user. Message content is selected by creating a targeting schema based on the received information regarding the user and implicitly deduced information and filtering message content based on the user schema. The user schema may be created by utilizing statistical analysis to compare and correlate the received information regarding the user and the implicitly deduced information.

This application claims the benefit of U.S. Provisional Application No. 60/179,258, which was filed on Jan. 31, 2000, the entirety of which is incorporated herein by reference.

### BACKGROUND OF THE INVENTION

The present invention is directed to a method and system for targeting messages to users. More particularly, the present invention is directed to a method and system for targeting messages to users based on event-specific information provided by the users and user profiles.

The Internet has grown significantly over the past few years. Several types of Internet connections are currently available. For example, a user may dial into a computer at an Internet Service Provider's (ISP's) facility using a modem and a standard telephone line. The ISP's computer, in turn, provides the user with access to the Internet. Through this Internet connection, the user can access information on the web using a computer program referred to as a web browser. The web browser is a software program that allows a user to view the data received from a website.

Websites are often associated with events, products or services of which users may wish to be informed and/or which companies may wish to advertise. When a user visits a website, he or she may volunteer or may be automatically designated to receive messages associated with the website, e.g., marketing offers for products or services and/or reminders regarding an event from companies associated with the website. Companies attempt to predict which users will be interested in receiving messages, based, e.g., on demographic information or buying histories of the users. Companies may also attempt to deliver messages at a time they believe users are likely to be receptive. Other than “opting in” or “opting out” to receive messages, the user typically does not have direct input as to what messages will be received, when they will be received, or how they will be received.

Using conventional message targeting techniques, a user may be inundated with unappealing messages at inconvenient times, or the user may not receive messages in which he or she is interested in a convenient manner. In either case, the conventional targeting mechanisms are inefficient.

There is thus a need for a messaging mechanism that effectively targets users with the right message, at the right time, in the right manner.

### SUMMARY OF THE INVENTION

The present invention is directed to a method and system for targeting messages to users in an efficient and effective manner.

According to exemplary embodiments, a method and system are provided for generating event-centric, personalized messages. Information regarding a user is received, including event-related information describing a desire by the user to receive information associated with an event at one or more specific time(s) or range(s) of time(s) and/or at one or more specific destination(s). Messages are then sent to the user at the specific time and/or at the specific destination corresponding to that contained in the received information.

The messages may include one or more offers for a particular product or service, reminders for the event, or information regarding other events associated with the event. The messages may be sent via an e-mail message, a message to a wireless-enabled device or a wireline device, or a facsimile.

According to exemplary embodiments, one or more specific messages are selected to send to the user based on the received information regarding the user. The received information may include information regarding the user's behavior with regard to messages previously received, demographic/psychographic information regarding the user, and information provided by a third party regarding the user. The messages may also be selected based on information deduced from the received information regarding the user. To select messages, a targeting schema is created based on the received information regarding the user and the implicitly deduced information, and the message content is filtered based on the user schema. The user schema may be created by utilizing statistical analysis to compare and correlate the received information regarding the user and the implicitly deduced information. A user profile may be created and updated using the received information, information deduced from the received information, and the schema. The message content provided for filtering may be content that satisfies the user profile.

The objects, advantages and features of the present invention will become more apparent when reference is made to the following description taken in conjunction with the accompanying drawings.

### BRIEF DESCRIPTION OF THE DRAWINGS

FIG. 1 is a block diagram illustrating a system for generating event-centric targeted messages according to an exemplary embodiment;

FIG. 2 illustrates a method for generating event-centric targeted messages according to an exemplary embodiment; and

FIG. 3 illustrates in more detail how a user profile is created/updated according to an exemplary embodiment.

### DETAILED DESCRIPTION OF THE INVENTION

According to exemplary embodiments, targeted messages are sent to users or consumers at the time(s) and destination(s) they designate. For this purpose, a user provides information describing a desire to receive a notification message associated with an event at a particular time(s) and destination(s), e.g., by entering such information via a website associated with the event or via an e-mail or wireless message to an address associated with the event.

The user is contacted at the appropriate time and destination with a message containing information associated with the event. This information may include a reminder about the event and/or information regarding a product, service, or other event(s) associated with the event. Once the user acts on the message or its content, a virtual data exchange commences, and an interactive forum is created.

As a result, behavioral data specifically related to the user's action regarding the event information, as presented, e.g., at the website or via the event notification message, is captured. The behavioral data is subsequently gathered by monitoring and recording the user's subscriptions to event-related messages and correlating this information with the user's past behavior with regard to when, how, and in what manner the user acted upon those messages. Typical behaviors may include the modification of the notification parameters, the addition of personal notes to be sent in the next notification, cancellation of the notifications, or the addition of other events associated with the original event.

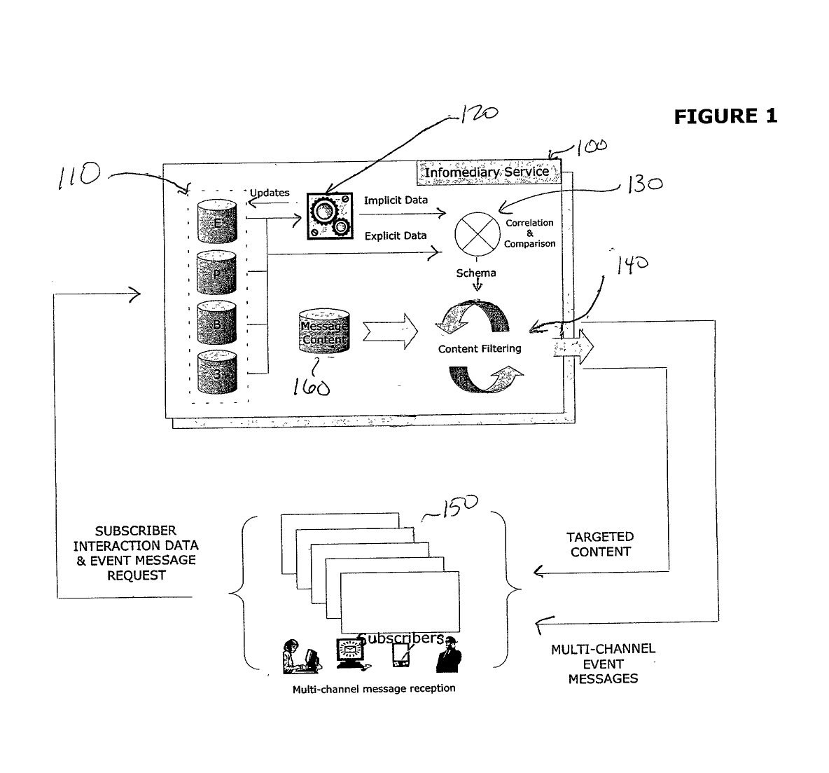

FIG. 1 illustrates a system for generating event-centric targeted messages according to an exemplary embodiment. The system includes an Infomediary Service Provider 100 that provides targeted messages, e.g., event reminders and targeted offers for products and services, to users or subscribers 150, along with multi-channel event messages. For ease of explanation, only one user is described below. However, it will be appreciated that the invention is applicable to any number of users.

The messages are targeted based on input to the Infomediary Service System Provider 100 that includes 1) explicit data regarding the behavior of users with regard to the messages and 2) data implicitly generated through the analysis of the explicit data. The explicit data may be provided directly by the user via a website associated with the event or a message to an address associated with the event. The explicit data may be provided in the form of actions on past reminders and offers, voluntarily supplied demographic/psychographic information and other information that can be used to describe the event or its parameters, e.g., time, date, or location. Explicit data may also be provided by a third party, e.g., a credit bureau or a retail organization. Implicit data is compiled and extrapolated from the explicit data regarding the user or event messages to which the user has subscribed.

As part of inputting explicit data, the user may select the time(s), manner(s), and destination(s) for delivery of messages. For example, the user may choose to have a message delivered at a particular time or range of times via e-mail to a computer terminal, via a facsimile to a terminal or facsimile machine, via a message to a wireless device such as a mobile telephone or any wireless-enabled device, e.g., a personal digital assistant, etc., or via a message to any wireline device. The user may choose to have the message delivered at one or more destinations, at one or more time(s) (or range(s) of time(s)), in one or more manners. The user may indicate these selections, e.g., upon visiting the website associated with the event.

As shown in FIG. 1, the Infomediary Service Provider 100 includes databases 110 for storing data including event-related information (e.g., time, place, location, personal reminders), behavioral data (e.g., user interaction with event parameters such as delivery modes, delivery location and notification frequency), profile data not related to the event or voluntarily supplied demographic/psychographic data, and data provided by a third party. The data stored in these databases, referred to as databases makes up a user profile.

Implicit data is extrapolated from the data stored in the databases 110 in an Implicit Data Generator 120. The implicit data may then be included in the user profile and stored, e.g., in one of the databases 110.

A Targeting Processor 130, e.g., a microprocessor, a bank of computers, or web servers, runs a targeting process using analytical/statistical methods, including correlation and comparison of the implicit and explicit data. Any conventional analytical/statistical process or tool, such as multivariate analysis of variance, cross-tabulation, linear and nonlinear regression, factor/neutral network analysis or collaborative filtering, may be used for this purpose.

The Targeting Processor 130 analyzes the implicit and explicit data and generates a schema. The Infomediary Service Message Engine 140 uses the schema to filter among message content provided by a message content provider. This message content may be stored, e.g., in a Message Content Database 160. Alternately, though not illustrated, the message content may be provided directly from a message content provider that has an association with the Infomediary Service Provider 100. The message content provided to the Infomediary Service Provider 100 may be content that satisfies the user profile regarding the event, depending on the needs and desires of the message content provider.

After filtering of the message content in the Infomediary Service Engine 140, information regarding the schema is fed back to the databases 110 to be stored as part of the user profile, resulting in messages that are more targeted to the user.

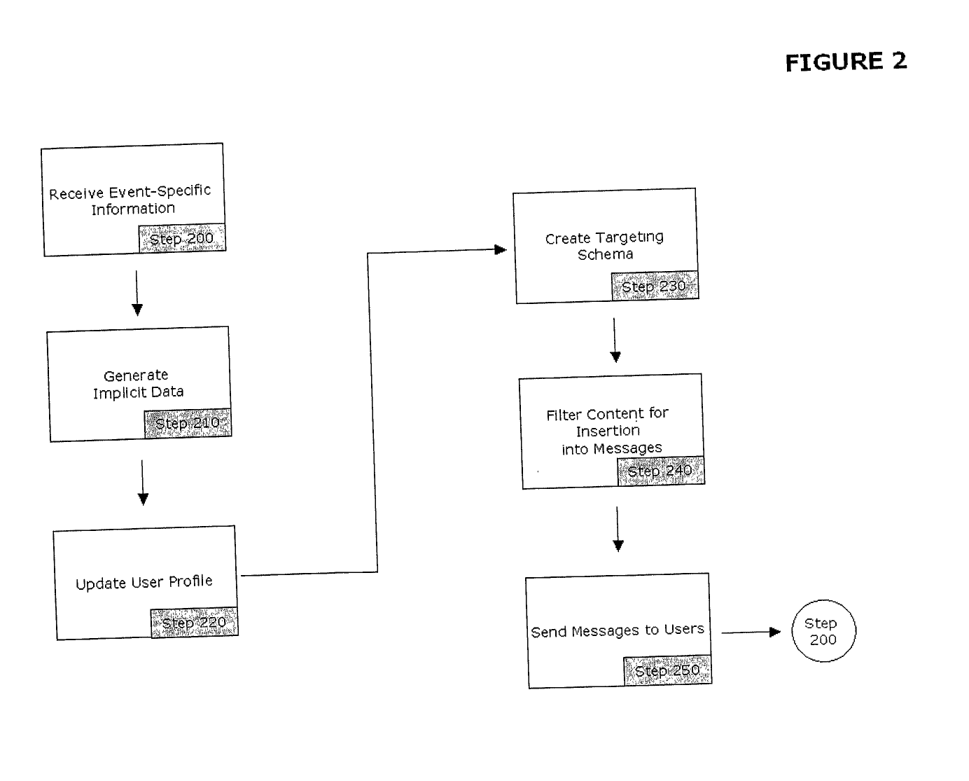

FIG. 2 illustrates a method for generating event-centric targeted messages to a user according to an exemplary embodiment. For simplicity of explanation, only one user is described below. However, it will be appreciated that this method may be applied to any number of users.

The method begins at step 200 at which event-related information is received from a user describing a desire to receive information associated with a specific event at a particular time(s) (or range(s) of time) and destination(s). This information may also include demographic/psychographic information volunteered by the user and/or third party information such as credit or buying history. At step 210, this explicitly gathered data that defines the relationship between the specific user and the event is passed to the Implicit Data Generator 120, and the Implicit Data Generator 120 generates implicit data based on the explicit data. At step 220, the user profile is updated based, e.g., on information obtained from the user input regarding demographics/psychographics or buying history, information regarding how the user responded to previous messages, third party information, and any implicit data. It will be appreciated that this step need not be performed in the order shown but may be performed and/or repeated at any point at which new information is gathered.

At step 230, the Targeting Processor 130 compares and correlates the explicit data and implicit data and uses the results to create a schema. At step 240, message content is filtered using the schema and is inserted into an appropriate message. The message content that is provided for filtering may be message content that satisfies the user profile, depending on the needs and desires of the message content provider.

At step 250, the selected message content is inserted into, e.g., appended to, messages sent to the user at the appropriate time(s) and the appropriate destination(s). The method may be repeated as necessary, as either additional event-specific information, demographic/psychographic, or behavioral data (regarding how the user responded to the previous information about events) is received.

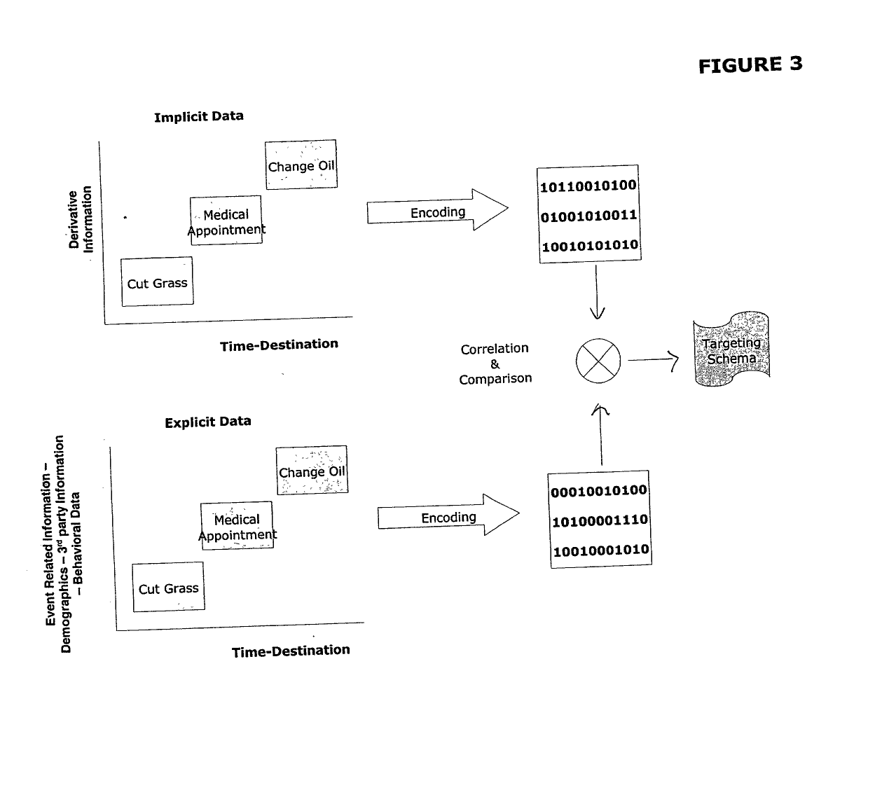

FIG. 3 illustrates, in more detail, how the targeting schema is created and updated. Explicit data regarding user-scheduled events, including the information desired, the time(s) and destination(s) of delivery desired, and the delivery mode desired, is collected. Also, explicit data regarding how users responded to messages associated with the events, i.e., when and whether the users responded and what the delivery options were for the messages to which users responded, are gathered over time. This explicit data is encoded. Additional third party environment data may also be encoded. This data is then processed in the Implicit Data Generator 120 that produces derivative information, and the implicit data is encoded.

The encoded data is correlated and compared, e.g., the explicitly and implicitly gathered information regarding a user's subscription to event-centric messages is correlated with information regarding the users past behavior with regard to when, how, and in what manner the user acted upon those messages, as well as any environmental information that may be useful. The result is a data string coded to uniquely describe the relationship between an event, a user associated with the event, and the message content. Feedback is continually provided to the message content provider regarding how the user acted on the messages, thus enabling the message content provider to continually improve the targeting of messages.

To illustrate how a targeting schema is created and updated, assume that messages are sent to user at a time, in a manner, and to a destination designated by the user, for cutting the grass, attending a medical appointment, and changing the oil. Assume, e.g., that the user requests that a reminder for cutting the grass and changing the oil be sent by e-mail a week in advance and that a reminder for a medical appointment be sent a night before the appointment. The data entered by the user regarding the reminders is collected as explicit data and encoded.

From this explicit data, additional information may be derived and stored as implicit data. For example, it may be deduced that the user requesting a message on cutting the grass in February is a homeowner with a home in an area with a warm climate and has a need to know about other lawn care products and services, such as fertilizer and aeration. If the user requested a message for a medical appointment, it may be deduced that the appointment was for an illness, and that the user has a subsequent interest in certain types of medication or information relevant to the illness or nature of the appointment.

Now assume that, after the time at which these events were scheduled, information is gathered regarding whether or not the user cut the grass, attended the medical appointment, and/or changed the oil. The information regarding how the user acted on the reminders is collected as explicit behavior data and encoded. The implicit data regarding the reminders is compared with the explicit data regarding how the user acted on the reminders. Also, information regarding third party behavior, e.g., a medical facility's charge to the consumer for not canceling a missed appointment in advance, and/or information regarding implicit environment data, e.g., an indication from the medical facility that this is a critical, life-threatening appointment, is appended to the user profile by the medical facility. As a result, a user profile is created or updated.

If the user acted on a reminder for a medical appointment that was delivered by e-mail the night before the appointment but did not act on the reminders to cut the grass or change the oil that were delivered by e-mail a week in advance, the user profile may include information that the user will act on reminders about events with which there may be associated critical health-related and/or financial consequences, delivered by e-mail shortly before the event. Then, offers and reminders would only be sent to the users regarding these types of events, delivered at this time, and in this manner.

Also, at the time that the user schedules to receive information associated with an event, e.g., an event reminder, he or she may be prompted for more information that may help in targeting messages. For example, for a change of oil event, a user may be prompted for the make and model of his or her car. This information may be used to target messages, e.g., offers for service or offers for a new car, to the user, based, e.g., on data regarding when other users of cars of similar makes and models bought new cars or had service performed.

As another example, consider that a user orders a cake for her daughter's birthday and that the user desires to be reminded of her order via an e-mail message to be delivered to her home computer the evening before the cake is ready to be picked up. Based on this order, message content may be selected based on what messages might be interesting to a woman with a daughter, sent via e-mail, in the evenings. For example, messages may be selected for advertising for birthday planning services.

Suppose that the order specified that the cake was for a sixteenth birthday, with a message “On your 16^{th} birthday, love Mom and Dad”, and with the instruction to decorate the cake with tennis rackets and balls. This explicit information may be used to narrow the selection of message content, e.g., to advertisements for teen birthday parties with a sports theme. Also, from this order, additional information may be deduced, e.g., it may be deduced that the daughter has two parents, that the parents are middle-aged, that the daughter may be in the market for a car soon, and that the daughter's birthday is within a week of the day the cake is scheduled to be picked up.

This implicitly generated information may be used to enhance an existing user profile for the family that will help narrow the selection of message content in the future.

The user may also be prompted for additional information at the time of the order, e.g., the ages and genders of siblings, whether the user ever ordered a cake in this manner before, etc. This information may be added to the user profile.

Also, it may be noted later when and whether the user actually picked up the cake. A comparison of the date and time at which the user picked up the cake with the time at which a reminder message was sent may help indicate whether or not the user actually used the reminder message. This information may also be added to the user profile for the family and may help in the targeting messages to the family.

According to exemplary embodiments, a method and system are provided which enable messages to be targeted to users effectively and efficiently. The invention allows message content providers to insert offers and other related information into messages that users have subscribed to receive. Thus, the invention enables message content providers to communicate with users on an event-centric basis that takes into account behavioral information regarding user-scheduled events associated with a product, service, or another event and/or information input by the user at the time of scheduling the event. The behavioral aspect enables the generation of an enriched user profile, since the user's subscription to event centric message is monitored, and this information is correlated with the user's past behavior with regard to when, how, and in what manner the user acted up those messages.

While traditional message targeting mechanisms are limited to attempts to provide the right message to the right person, the present invention allows more robust targeting by extending the right message at the right time and to the right destination. Unlike traditional messaging mechanisms, the present invention fully empowers the user/consumer. No other existing mechanism allows users to choose the time, manner, and destination for delivery of messages by a company that wishes to communicate with the users.

It should be understood that the foregoing description and accompanying drawings are by example only. A variety of modifications are envisioned that do not depart from the scope and spirit of the invention.

The above description is intended by way of example only and is not intended to limit the present invention in any way.

What is claimed is:

1. A computer-implemented method for generating event-centric personalized messages, comprising the steps of:
receiving information regarding a user, including event-related information from the user describing a desire by the user to receive information associated with an event at one or more specific time(s) or range(s) of time(s) and/or at one or more specific destination(s); and
selecting one or more specific messages based on the received information regarding the user.

2. The method of claim 1, further comprising the step of sending the messages to the user at the specific time and/or at the specific destination corresponding to that contained in the received information.

3. The method of claim 1, wherein the received information includes information regarding the user's behavior with regard to messages previously received, demographic/psychographic information regarding the user, and information provided by a third party regarding the user.

4. The method of claim 1, further comprising selecting one or more specific messages based on information deduced from the received information regarding the user.

5. The method of claim 4, wherein the step of selecting comprises creating a targeting schema based on the received information regarding the user and implicitly deduced information and filtering message content based on the user schema.

6. The method of claim 5, wherein the step of creating the user schema comprises utilizing statistical analysis to compare and correlate the received information regarding the user and the implicitly deduced information.

7. The method of claim 1, further comprising a step of creating and updating a user profile using the received information and information deduced from the received information.

8. The method of claim 7, further comprising the step of updating the user profile information based on the schema.

9. The method of claim 8, wherein the step of selecting filtering filters selected message content that satisfies the user profile.

10. The method of claim 1, wherein the messages include at least one of offers for a particular product or service, reminders for the event, or information regarding other events associated with the event.

11. The method of claim 2, wherein the step of sending comprises transmitting at least one of an e-mail message, a message to a wireless-enabled device or a wireline device, or a facsimile.

12. A system for generating event-centric personalized messages, comprising:
a data storage that stores received information regarding a user; and
computing equipment coupled to the data storage and which receives the information regarding a user, including information describing a desire by the user to receive information related to an event at one or more specific time(s) or range(s) of time(s) and/or at one or more specific destination(s), and selects one or more specific messages based on the received information regarding the user.

13. The system of claim 12, wherein the computing equipment sends information to a user containing the message at the specific time and/or at the specific destination corresponding to that contained in the received event-specific information.

14. The system of claim 12, wherein the received information includes information regarding the user's behavior with regard to messages previously received, demographic/psychographic information regarding the user, information provided by a third party regarding the user.

15. The system of claim 12, wherein the computing equipment further selects one or more specific messages based on information deduced from the receiving information regarding the user.

16. The system of claim 15, wherein the computing equipment selects messages by creating a targeting schema based on the received information and implicitly deduced information and filtering message content based on the user schema.

17. The system of claim 16, wherein the computer equipment creates the user schema by utilizing statistical analysis to compare and correlate the received information regarding the user and the implicitly deduced information.

18. The system of claim 12, wherein the computing equipment creates and updates a user profile using the received information and information deduced from the received information.

19. The system of claim 18, wherein the computing equipment updates the user profile based on the schema.

20. The system of claim 19, wherein the computer equipment filters selected message content that satisfies the user profile based on the user schema.

21. The system of claim 13, wherein the messages include at least one of offers for a particular product or service, reminders for the event, or information regarding other events associated with the event.

22. The system of claim 12, wherein the computing equipment sends information by at least one of an e-mail message, a message to a wireless-enabled device or a wireline device, or a facsimile.

23. The system of claim 12, further comprising a plurality of user sites at which users are located, wherein the user sites communicate with the computing equipment over one or more communication networks.
